(19) United States
(12) Patent Application Publication
(10) Pub. No.: US 2025/0362961 A1
(43) Pub. Date: Nov. 27, 2025

(54) PLATFORM WITH NATIVE OPERATIONS DYNAMICALLY MAPPED TO EXTERNAL SERVICES

(71) Applicant: Lionsoul Global Inc., Austin, TX (US)

(72) Inventors: Alexey Bulavin, London (GB); Jerome Edward Gudgeon, Redhill (GB)

(21) Appl. No.: 19/216,625

(22) Filed: May 22, 2025

Related U.S. Application Data
(60) Provisional application No. 63/651,341, filed on May 23, 2024.
(60) Provisional application No. 63/651,336, filed on May 23, 2024.

(51) Int. Cl. G06F 9/50

(52) U.S. Cl. CPC G06F 9/5027

(57) ABSTRACT

The present disclosure addresses the technical challenge of integrating heterogeneous external service interfaces—each with its own protocol and data format by defining a uniform, implementation-agnostic set of “native” operations. At runtime, for each native operation, the system automatically identifies candidate remote endpoints, selects an optimal provider based on real-time performance metrics such as latency or reliability, and retrieves a stored mapping from an interface-mapping repository to transform the native operation into the provider's required protocol. This framework enables seamless, automated execution of multi-step workflows across diverse computing systems and allows new service endpoints to be integrated simply by adding corresponding mappings-without modifying existing workflow definitions. By decoupling high-level process logic from service-specific formats and introducing dynamic provider selection and on-the-fly protocol conversion, the system can deliver a tangible technical improvement in distributed computing systems by improving interoperability and maintenance efficiency.

### RELATED APPLICATIONS

This application claims the benefit of U.S. Provisional Application No. 63/651,341, filed May 23, 2024, and U.S. Provisional Application No. 63/651,336, filed May 23, 2024, which are incorporated by reference.

### BACKGROUND

### 1. Technical Field

The present disclosure relates generally to interoperability of online services, and more particularly to dynamically mapping operations defined in a native format to formats used by external service providers.

The present disclosure further relates generally to improvements in distributed computing systems, and more particularly to methods and systems for enabling seamless interoperability and automated management of digital data items across heterogeneous storage locations and processing modes.

### 2. Background Information

Modern distributed computing environments often require systems to interact with multiple external services, each exposing its own application programming interface (API) and using distinct data formats. Integrating such heterogeneous interfaces typically demands bespoke adapters or middleware for every service, resulting in significant development and maintenance overhead.

Existing platforms that perform multi-endpoint operations lack mechanisms to dynamically select the most suitable service provider at runtime. Optimization based on performance metrics—such as latency, reliability, or error rates—usually requires manual reconfiguration or hard-coded logic for each provider, preventing seamless adaptation to changing conditions. Furthermore, incorporating new external endpoints into these systems is cumbersome. Each addition often necessitates modifying core workflow definitions or writing new integration code, hindering scalability and rapid deployment of new services. These technical limitations lead to rigid architectures that cannot automatically orchestrate, optimize, or extend multi-service workflows without extensive human intervention.

Furthermore, modern distributed computing environments and online platforms frequently require the management of digital data items—such as files, tokens, or other data objects—across multiple logical partitions, user-associated storage locations, and shared domains. However, existing systems often suffer from technical limitations that impede efficient and secure data management. For example, data migration between different storage locations or processing modes can be administratively complex, prone to errors, and may require significant manual intervention. Inconsistent or non-standardized tagging and status indicators for data items can lead to data integrity issues, increased risk of data loss, and difficulties in tracking the state and location of data objects within the system.

A significant technical challenge arises when users or automated processes need to reassign digital data items between different processing modes or storage domains, each of which may have distinct requirements for custody, access control, and metadata management. Existing solutions often lack mechanisms for automated status tagging, seamless reassignment, and efficient transfer of data items, resulting in increased latency, reduced system reliability, and suboptimal resource utilization. As a result, current distributed platforms are not conducive to providing users or applications with flexible, secure, and efficient management of digital data items across diverse system components.

### SUMMARY

The present disclosure addresses the technical challenge of integrating heterogeneous external service interfaces—each with its own protocol and data format by defining a uniform, implementation-agnostic set of “native” operations. At runtime, for each native operation, the system automatically identifies candidate remote endpoints, selects an optimal provider based on real-time performance metrics such as latency or reliability, and retrieves a stored mapping from an interface-mapping repository to transform the native operation into the provider's required protocol. This framework enables seamless, automated execution of multi-step workflows across diverse computing systems and allows new service endpoints to be integrated simply by adding corresponding mappings—without modifying existing workflow definitions. By decoupling high-level process logic from service-specific formats and introducing dynamic provider selection and on-the-fly protocol conversion, the system can deliver a tangible technical improvement in distributed computing systems by improving interoperability and maintenance efficiency.

Furthermore, a computing system that may provide seamless interoperability and automated management of digital data items across multiple storage locations and processing modes. In various embodiments, when a user or process introduces digital data items into the system, the items are stored in a user-associated storage location and assigned a status indicator denoting their availability for further processing. The system enables the selection of a first processing mode, where the digital data items are tagged with an identifier corresponding to that mode while remaining in the user-associated storage location.

At a later stage, the system may receive a selection of a second processing mode for some or all of the digital data items previously associated with the first processing mode. The system automatically updates the status indicators of the relevant data items to reflect their availability for reassignment and initiates a transfer of the data items from the user-associated storage location to a storage location associated with the second processing mode. This process may be performed in response to user input or automated system logic, and can be executed with minimal latency and without manual intervention.

In certain embodiments, the system provides a user interface for monitoring, selecting, and managing the status and location of digital data items, and may support additional features such as automated metadata management, access control, and integration with third-party service providers or system resources.

By automating the tagging, reassignment, and transfer of digital data items between heterogeneous storage locations and processing modes, the described system provides a technical improvement in distributed computing environments. It enhances data integrity, reduces the risk of data loss or corruption, and enables more efficient and reliable management of digital data items. These improvements facilitate greater interoperability between system components, reduce administrative overhead, and support scalable, flexible data management across a wide range of applications and platforms.

### BRIEF DESCRIPTION OF THE DRAWINGS

FIG. 1 is a block diagram of a networked computing environment suitable for enabling transactions involving digital assets, according to one embodiment.

FIG. 2 is a block diagram of the digital assets platform shown in FIG. 1, according to one embodiment.

FIG. 3 illustrates implementation of an example strategy using native operations, according to one embodiment.

FIG. 4 is a flowchart of a process for the digital assets platform implementing a transaction using a third-party service, according to one embodiment.

FIG. 5 is a block diagram of the digital assets platform shown in FIG. 1, according to one embodiment.

FIG. 6 illustrates an example entity and wallet structure for providing interoperability between account types, according to one embodiment.

FIG. 7 is a flowchart of a process for transferring a digital asset between account types for different strategies, according to one embodiment.

FIG. 8 is a block diagram illustrating an example of a computer suitable for use in the networked computing environment of FIG. 1, according to one embodiment.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

There is currently significant interest in digital assets such as cryptocurrencies, non-fungible tokens, derivatives and funds involving digital assets, and other decentralized finance (DeFi) assets. However, implementation of such strategies involving such assets is hampered by several technical limitations of existing platforms and services. Crypto exchanges often place limits on volume of trades by individuals. Many platforms do not provide direct ownership of assets and are subject to significant risk of fraud. Some investors opt to directly store their own digital assets, but this is administratively cumbersome and leads to increased risk of theft or other losses of assets. One significant technical problem that arises is that efficient implementation of a digital asset strategy is that optimization of trades and other operations involving digital assets typically involves interacting with multiple third-party services or platforms, each of which have their own requirements for requesting services. Thus, pre-existing digital asset platforms cannot automatically perform operations with the optimal third-party service.

The above and other problems may be addressed by a digital assets platform that provides seamless integration with a range of third-party services, such as custodians, DeFi protocols, and exchanges. In various embodiments, the digital assets platform defines operations using a set of native operations. When implementing an operation that involves interaction with a third-party service, the digital assets platform identifies one or more candidate third-party providers for the service, selects one of the third-party providers, and maps the interaction as defined using the native operations into a format used by the selected third-party provider. This may enable the digital assets platform to automatically implement the operation in conjunction with the third-party provider without the need for human intervention. Furthermore, a new third-party provider may be easily added to those that can be used by the digital assets platform by simply providing a mapping between the native operations and the format used by the new third-party provider.

### Example Systems

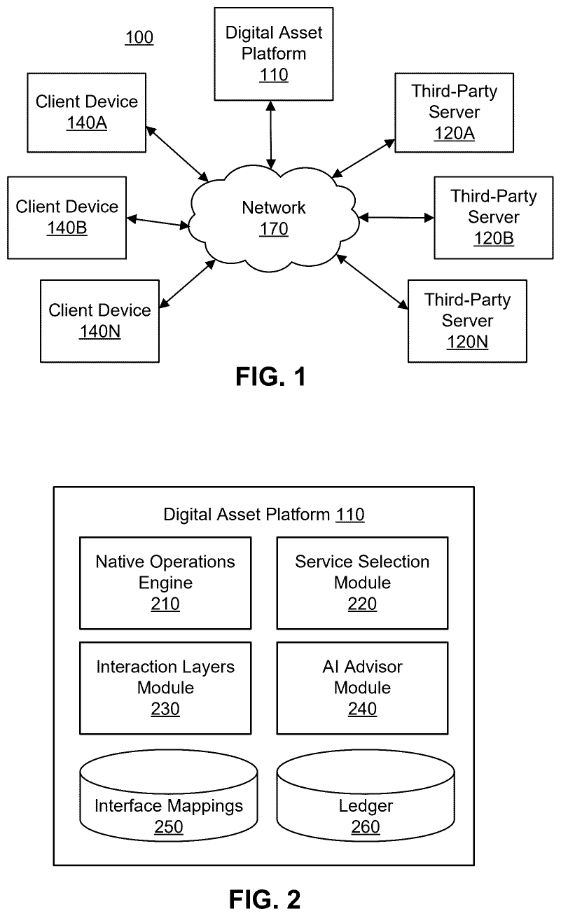

FIG. 1 illustrates one embodiment of a networked computing environment 100 suitable for providing transactions involving digital assets. In the embodiment shown, the networked computing environment 100 includes a digital assets platform 110, one or more third-party servers 120A-N, and one or more client devices 140A-N, all connected via a network 170. In other embodiments, the networked computing environment 100 includes different or additional elements. In addition, the functions may be distributed among the elements in a different manner than described.

The digital assets platform 110 enables users to manage portfolios of digital assets. Users may deposit digital assets into the ecosystem managed by the digital assets platform. In some configurations, users may also acquire digital assets provided natively in the ecosystem (e.g., by providing fiat currency in exchange for tokens of a cryptocurrency provided by the digital assets platform). In one embodiment, the digital assets platform 110 may enable users to implement various investment strategies using one or more of a set of native operations. The implemented strategies may involve operations that are implemented within the digital assets platform 110, operations in which digital assets platform causes third-party servers 120 to provide services by mapping one or more native operations to a format used by a third-party server 120, or a combination of both. Various embodiments of the digital assets platform 110 and approaches to mapping native operations to formats used by third-party servers 120 are described in greater detail below, with reference to FIG. 2.

A third-party server 120 is one or more computing devices that provide digital asset services, such as exchanges, DeFi protocols, or custodial services, etc. Although three third-party servers 120A, 120B & 120N are shown the networked computing environment 100 may include any number of such servers. In one embodiment, each third-party server 120 receives requests for services and provides the results of processing those requests using its own operation format that is different from the format of the native operations. For example, a third-party server 120 may provide an API with a set of functions via which the digital assets platform 110 (and other devices) may access one or more services provided by the third-party server 120. As mentioned previously, the digital assets platform 110 may use a mapping between its native operation format and the format used by the third-party server 120 to automatically implement operations using the service or services provided by the third-party server 120.

A client device 140 is a computing device with which users interact with the digital assets platform 110. Although three client devices 140A, 140B & 140N are shown, the networked computing environment 100 can include any number of such devices. In one embodiment, a client device 140 provides a user interface (e.g., within a dedicated application or via a webpage hosted by the digital assets platform accessed via a browser) with which the user can deposit and withdraw digital assets or fiat currency into or out of the digital assets platform 110, respectively. The user may also use the user interface to select investment strategies for deposited assets. For example, the user may deposit or purchase cryptocurrency and assign the cryptocurrency to one or more separately managed accounts (SMAs), native funds, third-party funds, or any other investment strategies provided by the digital assets platform 110. The user interface 140 may also include a dashboard or similar interface via which the user can monitor performance of their investments and access other information about their portfolio of digital assets.

The network 170 provides the communication channels via which the other elements of the networked computing environment 100 communicate. The network 170 can include any combination of local area and wide area networks, using wired or wireless communication systems. In one embodiment, the network 170 uses standard communications technologies and protocols. For example, the network 170 can include communication links using technologies such as Ethernet, 802.11, worldwide interoperability for microwave access (WiMAX), 3G, 4G, 5G, code division multiple access (CDMA), digital subscriber line (DSL), etc. Examples of networking protocols used for communicating via the network 170 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 170 may be represented using any suitable format, such as hypertext markup language (HTML) or extensible markup language (XML). In some embodiments, some or all of the communication links of the network 170 may be encrypted using any suitable technique or techniques.

FIG. 2 illustrates one embodiment of the digital assets platform 110. In the embodiment shown, the digital assets platform 110 includes a native operations engine 210, a service selection module 220, an interaction layers module 230, an AI advisor module 240, interface mappings 250, and a ledger 260. In other embodiments, the digital assets platform 110 includes different or additional elements. In addition, the functions may be distributed among the elements in a different manner than described.

The native operations engine 210 provides a set of native operations, which are fundamental operations such as asset transfers, smart contract executions, and trade order placements. These native operations can be chained together to create complex transactional chains to implement a wide range of investment strategies and transactions. In one embodiment, the interactions that can be implemented using native operations include: investments, redemptions, withdrawals, portfolio rebalancing, staking Etherium (ETH) (e.g., using the Lido or Rocketpool staking protocols), restaking ETH (e.g., using the EigenLayer staking protocol), lending restaked ETH (e.g., using the Aave or Compound lending protocols), and providing restaked ETH to a liquidity pool, etc. Using chains of operations with these (or similar third-party service providers) can provide integrity and reliable execution of complex financial actions.

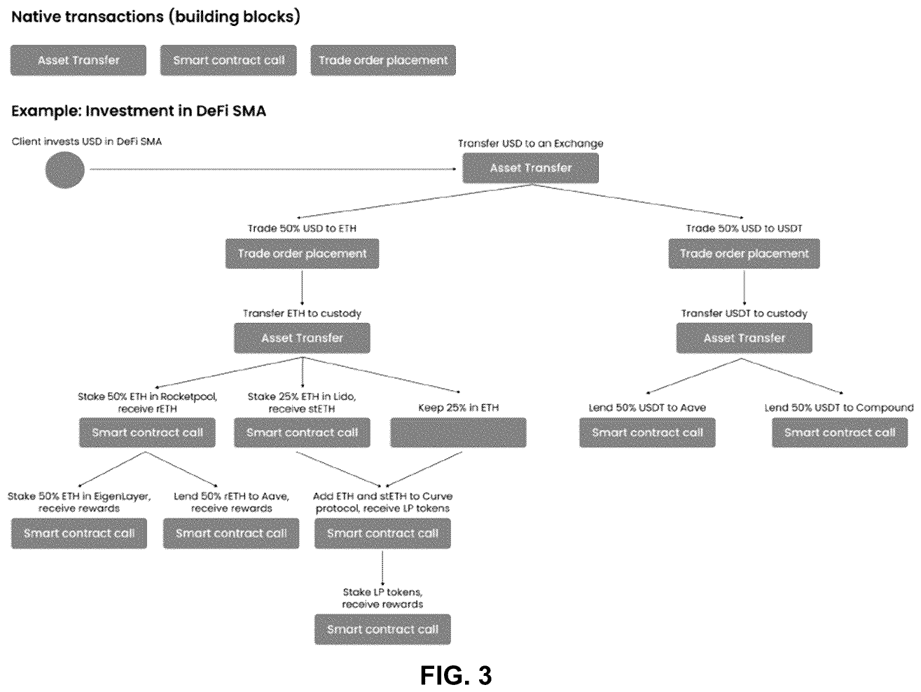

For example, FIG. 3 illustrates an example strategy for a SMA that may be implemented using native operations. Implementing the set of native operations involves using numerous services provided by third-party server 110. For example, converting a portion of the user's deposited fiat currency (in this case USD) to ETH involves placing a trade order with an exchange. For any given service, there may be multiple third-party servers 120 that can provide the desired service (or there may be a choice between providing the service within the digital assets platform or using one or more third-party servers 120). The service selection module 220 selects which entity will be used to provide the service at the time the service is requested by a native operation.

In one embodiment, the service selection module 220 obtains real-time or close to real-time data regarding candidate service providers and selects which provider to use based on the retrieved data. For example, the service selections module 220 may consider one or more of a cost for providing the service, an exchange or other rate provided for the service, a predicted time for the provider to complete the service, a probability of the provider being unable to service the request, or user preferences for selection of providers in determining which candidate service provider to select.

Once a service provider has been selected, the interaction layers module 230 determines how to request the desired service from the selected provider. Specifically, the interaction layers module 230 provides interaction layers that map operations defined in the native format to the APIs or other interfaces provided by different service providers. In one embodiment, the interaction layers module 230 accesses a mapping for the selected service provider (e.g., by querying a database of interface mappings 250 stored in one or more computer-readable media). The mapping converts the operation as defined in the native format to the format used by the selected service provider. The interaction layers module 230 can thus use the combination of the operation in the native format and the mapping to interact with a third-party server 120 of the selected provider to implement the desired service (e.g., placing on order on an exchange, staking a cryptocurrency with a smart contract call, lending a cryptocurrency with a smart contract call, etc.).

Using the combination of the native operations and the mappings, the digital assets platform can provide flexible creation, removal, and modification of model portfolios (e.g., predefined allocations of assets within a SMA) and fund investment strategies (where the platform acts as an interface for subscriptions in and withdrawals from funds). The use of native operations and mappings also enables flexible connectivity with new DeFi platforms and protocols by simply providing the appropriate mapping between the native operations and the format used by the new platform of protocol. Similarly, the types of assets that may be deposited into and withdrawn from the platform can be easily managed with modifications to the native operations available (e.g., a new type of asset may be accepted for deposit by adding a native operation that defines how that type of asset is injected into the platform). Furthermore, because the services used are selected at the time operations are performed, execution strategies may be optimized (e.g., using different exchanges for transactions using different types of assets as part of implementation of a larger strategy) for a wide range of parameters (e.g., minimizing transaction costs, minimizing implementation time, minimizing tax exposure, etc.).

The AI advisor module 240 can provide dynamic recommendations to users regarding available products and investment strategies. In one embodiment, the AI advisor module 240 asks a user a set of initial questions regarding their goals and preferences and provides one or more recommendations for products or strategies. The AI advisor module 240 may be driven by a trained machine-learning model based on product/strategy selections made by previous users who provided similar answers to the current user in response to the questions. The AI advisor module 240 may additionally or alternatively consider other information about the user, such as information provided in a user profile, prior selections made by the user, and one or more metrics indicating current market conditions.

The ledger 260 includes one or more non-transitory computer-readable media that store a record of assets held by users and transactions made within the digital assets platform 110. In one embodiment, assets are initially labelled as deposited assets when injected into the digital assets platform 110. If the user elects to allocate assets to a SMA, ownership/custody of those assets is not modified in the ledger 260, but the ledger 260 is updated to label the assets as assigned to the SMA. Conversely, if the user elects to invest assets in a fund, those assets are relabeled as deposited assets (if they had been previously assigned to a SMA and labeled accordingly) and a trade order is placed to transfer the assets from the user's custody to a custodial account of the fund. The ledger 260 may maintain a record of a user's investments in funds or the digital assets platform 260 may retrieve information about a user's investments from the fund as needed (e.g., by querying an API the fund).

### Example Methods

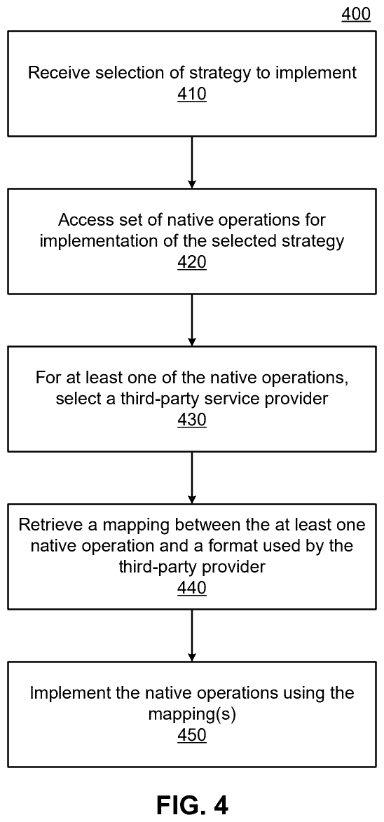

FIG. 4 illustrates a method 400 for implementing an example strategy using native operations, according to one embodiment. The steps of FIG. 4 are illustrated from the perspective of the digital assets platform 110 performing the method 400. However, some or all of the steps may be performed by other entities or components. In addition, some embodiments may perform the steps in parallel, perform the steps in different orders, or perform different steps.

In the embodiment shown, the method 400 begins with the digital assets platform 110 receiving 410 a selection of a strategy to implement. For example, a user may select a model portfolio to implement using their client device 140, and the client device 140 sends an instruction to the digital assets platform 110 to build the selected model portfolio for the user using their deposited assets. The digital assets platform 110 accesses 420 a set of native operations for implementation of the selected strategy. As described previously, the set of native operations is a set of fundamental operations such as asset transfers, smart contract executions, and trade order placements, defined in a format that is native to the digital assets platform 110. Some of the operations may be performed natively within the digital assets platform 110 but at least one may involve using a third-party service.

For any of the operations that require the use of a third-party service, the digital assets platform 110 selects 430 a third-party service provider to use from a set of candidate service providers (which may include the digital assets platform 110 providing the service natively). The digital assets platform 110 may select 430 which service provider to use based on real-time or close to real-time data, such as a cost for providing the service, an exchange or other rate provided for the service, a predicted time for the provider to complete the service, a probability of the provider being unable to service the request, or user preferences for selection of providers, etc.

For services that the digital assets platform 110 selects 430 a third-party service provider, the digital assets platform 110 retrieves 440 a mapping between the native operation that calls the service and a format used by the selected third-party service provider. The digital assets platform 110 implements 450 the set of native operations. For any of the native operations that involve the use of a third-party service, the digital assets platform uses the identified mapping to convert the native operation into the format used by the selected service provider and interfaces with the provider's third-party server 120 to implement those operations. Thus, the set of native operations for any given strategy can be independent of the service providers used to implement the strategy, with the mappings used to convert the native operations to the appropriate format to interface with service providers that are selected at execution time to optimize implementation of the strategy.

### Additional Example Systems

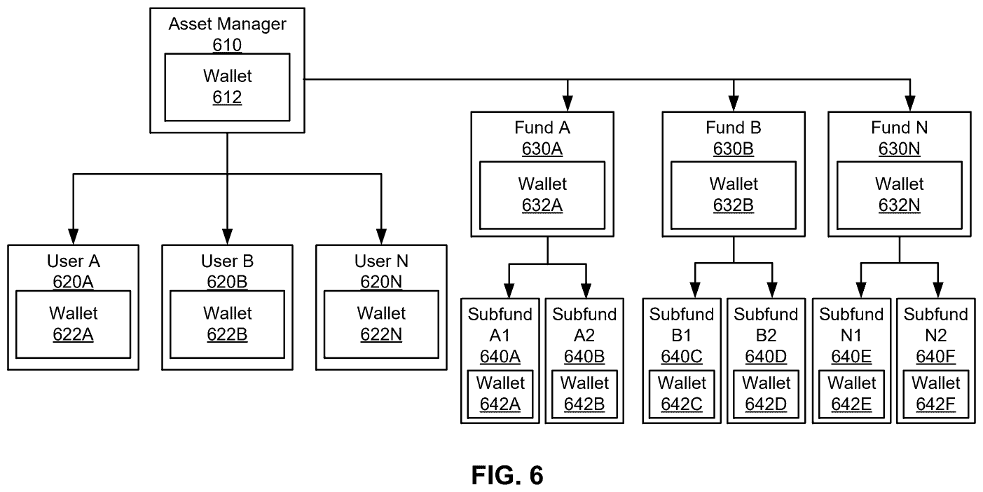

FIG. 6 illustrates one embodiment of the digital assets platform 110. In the embodiment shown, the digital assets platform 110 includes an onboarding module 505, a transaction processing engine 510, a service selection module 520, an interaction layers module 530, an AI advisor module 540, KYC data 545, interface mappings 550, and a ledger 560. In other embodiments, the digital assets platform 510 includes different or additional elements. In addition, the functions may be distributed among the elements in a different manner than described.

The onboarding module 505 enables users to create and manage accounts with the digital assets platform 510. In one embodiment, a user provides information such as contact details (email address, phone number, etc.). The onboarding module 505 creates an account for the user that has a unique userID. The unique userID may be a number, a text string, an alphanumeric string, the user's email address or phone number, or any other data object that can uniquely identify the user within the digital assets platform 510. The user account is associated with one or more custodial wallets in which the user can store digital assets that are deposited to (or obtained within) the digital assets platform 510. The onboarding module 505 may also solicit the user to provide information to perform any required KYC checks for one or more relevant jurisdictions. The onboarding module 505 may store provided KYC information (e.g., in the KYC data 545).

The transaction processing engine 510 processes transactions requested by users. The transaction processing engine may use a set of native operations, which are fundamental operations such as asset transfers, smart contract executions, and trade order placements. These native operations can be chained together to create complex transactional chains to implement a wide range of investment strategies and transactions. In one embodiment, the interactions that can be implemented using native operations include: investments, redemptions, withdrawals, portfolio rebalancing, staking Etherium (ETH) (e.g., using the Lido or Rocketpool staking protocols), restaking ETH (e.g., using the EigenLayer staking protocol), lending restaked ETH (e.g., using the Aave or Compound lending protocols), and providing restaked ETH to a liquidity pool, etc. Using chains of operations with these (or similar third-party service providers) can provide integrity and reliable execution of complex financial actions.

Some or all of the operations may involve interacting with third-party services, each of which may potentially be serviced by more than one service provider. The service selection module 520 selects which entity will be used to provide service at the time the services are requested by a native operation. In one embodiment, the service selection module 520 obtains real time or close to real time data regarding candidate service providers and selects which provider to use based on the retrieved data. For example, the service selections module 520 may consider one or more of a cost for providing the service, an exchange or other rate provided for the service, a predicted time for the provider to complete the service, a probability of the provider being unable to service the request, or user preferences for selection of providers in determining which candidate service provider to select.

Once a service provider has been selected, the interaction layers module 530 determines how to request the desired service from the selected provider. Specifically, the interaction layers module 530 provides interaction layers that map operations defined in the native format to the APIs or other interfaces provided by different service providers. In one embodiment, the interaction layers module 530 accesses a mapping for the selected service provider (e.g., by querying a database of interface mappings 550 stored in one or more computer-readable media). The mapping converts the operation as defined in the native format to the format used by the selected service provider. The interaction layers module 530 can thus use the combination of the operation in the native format and the mapping to interact with a third-party server 520 of the selected provider to implement the desired service (e.g., placing on order on an exchange, staking a cryptocurrency with a smart contract call, lending a cryptocurrency with a smart contract call, etc.).

The digital assets platform 510 provides a range of strategies for using digital assets. In one embodiment, the strategies include assigning digital assets to one or more SMA, one or more funds, or a combination of both. When a user deposits or otherwise obtains a digital asset in the digital assets platform 510, the digital asset is added to the user's wallet and tagged as a “deposited asset” indicating it is available for allocation to a strategy. Using a user interface (e.g., provided at the user's client device 540), the user may select a strategy to which the digital asset should be assigned. If the strategy is an SMA, the assets are tagged with an identifier of the SMA. The transaction processing module 510 may then implement one or more trades to obtain the desired allocation according to the SMA (e.g., a model portfolio defined for the SMA). Thus, the strategy is implemented with the user having custody over the digital assets in the user's wallet. If the strategy is a fund, the transaction processing module 510 implements one or more trades to move digital assets from the user's wallet to a wallet of the fund. If any digital assets the user selects to assign to the fund were currently assigned to an SMA, the transaction processing module 510 may first change the tag of those assets back to “deposited asset” to make them available for transfer. The transaction processing module 510 may then initiate a trade to transfer the assets from the user's wallet to the fund's wallet.

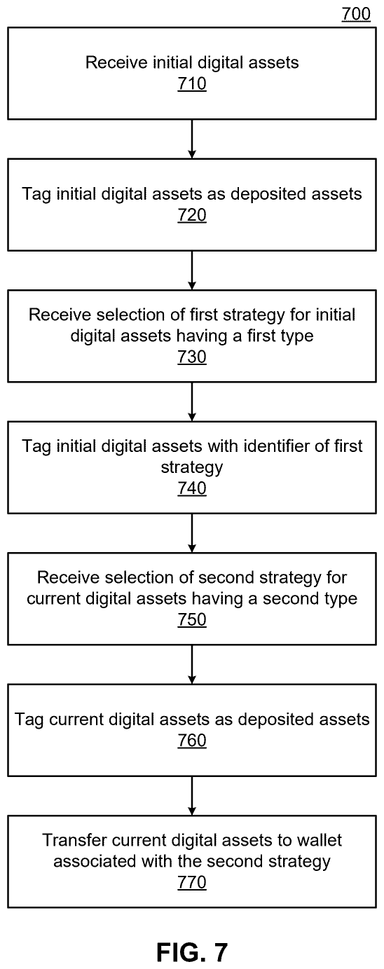

FIG. 7 illustrates an example entity and wallet structure for providing interoperability between account types, according to one embodiment. In the embodiment shown, an asset manager 610 (e.g., the entity operating the digital assets platform 510) has a wallet 612. This wallet 612 does not hold digital assets on behalf of users. Rather, the wallet 612 is used to receive fees paid by users for services provided by the digital assets platform 510.

Each user has as profile 620 that includes a wallet 622. In FIG. 7, there are three users 620A, 620B, and 620N, with corresponding wallets 622A, 622B, and 622N, but there can be any number of users 620 of the digital assets platform 510. The wallet 622 of a user holds digital assets deposited by the user 620 as well as any digital assets allocated to SMAs.

There is also a profile for each fund 630, each with a corresponding wallet 632. Although three funds 630A, 630B, and 630N are shown, with corresponding wallets 632A, 632B, and 632N, there can be any number of funds 630 that may be invested in via the digital assets platform 510. The wallets 632 of the funds 630 may hold digital assets assigned to the funds 630 by multiple users. Some or all of the funds 630 may be split into subfunds 640. For example, in FIG. 7, each fund 630 has two subfunds resulting in six subfunds 30A through 640F. Each subfund 640 has a corresponding wallet 642A through 642F. When digital assets are initially assigned to a fund 630 they may be added to the wallet 632 of the fund and then some or all of the digital assets may be divided between the subfunds 640 according to one or more allocation rules and the digital assets are transferred to the corresponding wallets 642 accordingly.

Referring back to FIG. 6, the AI advisor module 540 can provide dynamic recommendations to users regarding available products and investment strategies. In one embodiment, the AI advisor module 540 asks a user a set of initial questions regarding their goals and preferences and provides one or more recommendations for products or strategies. The AI advisor module 540 may be driven by a trained machine-learning model based on product/strategy selections made by previous users who provided similar answers to the current user in response to the questions. The AI advisor module 540 may additionally or alternatively consider other information about the user, such as information provided in a user profile, prior selections made by the user, and one or more metrics indicating current market conditions.

The ledger 560 includes one or more non-transitory computer-readable media that store a record of assets held by users and transactions made within the digital assets platform 510. In one embodiment, assets are initially labelled as deposited assets when injected into the digital assets platform 510. If the user elects to allocate assets to a SMA, ownership/custody of those assets is not modified in the ledger 560, but the ledger 560 is updated to label the assets as assigned to the SMA. Conversely, if the user elects to invest assets in a fund, those assets are relabeled as deposited assets (if they had been previously assigned to a SMA and labeled accordingly) and a trade order is placed to transfer the assets from the user's custody to a custodial account of the fund. The ledger 560 may maintain a record of a user's investments in funds or the digital assets platform 560 may retrieve information about a user's investments from the fund as needed (e.g., by querying an API the fund).

### Additional Example Methods

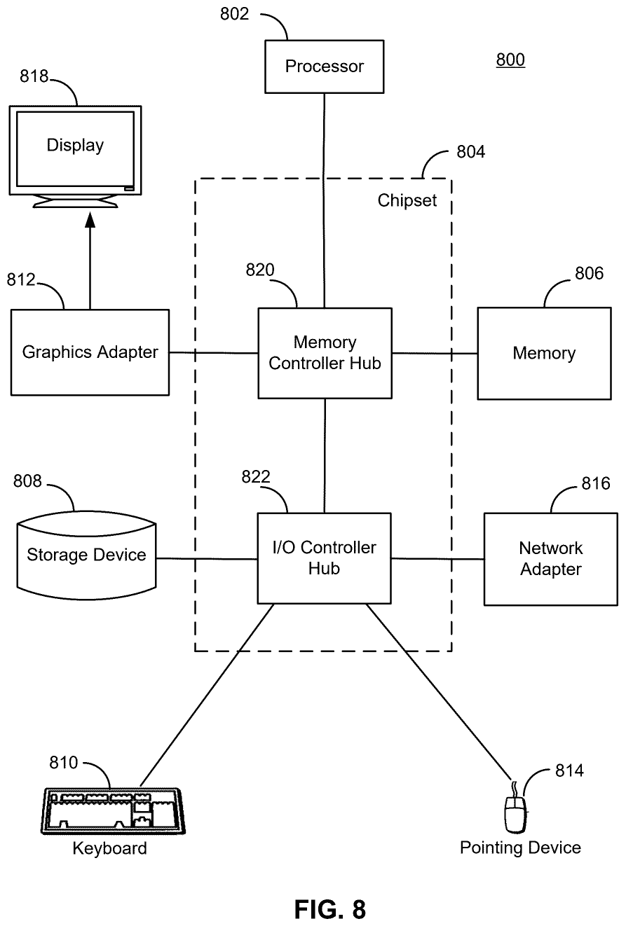

FIG. 8 illustrates a method 700 for transferring a digital asset between account types for different strategies. The steps of FIG. 8 are illustrated from the perspective of the digital assets platform 510 performing the method 700. However, some or all of the steps may be performed by other entities or components. In addition, some embodiments may perform the steps in parallel, perform the steps in different orders, or perform different steps.

In the embodiment shown, the method 700 begins with the digital assets platform 510 receiving 710 an initial set of digital assets. The initial digital assets may be deposited with the digital assets platform 510 by the user from an external source or obtained by the user within the digital assets platform. The initial digital assets are tagged 720 as deposited assets indicating they are available to be associated with strategies. The digital assets platform 510 receives 730 selection of a first strategy for the initial digital assets. For example, a user may make a selection via a user interface provided at a client device 540 that sends the selection via the network 570 to the digital assets platform 510. The first strategy has a first type (e.g., associating the initial digital assets with a SMA). The digital assets are tagged 740 with an identifier of the first strategy (e.g., an identifier of the SMA).

At a later time, the digital assets platform 510 receives 750 selection of a second strategy of a second type for some or all of the assets currently assigned to the first strategy. As before, the selection may be provided via a user interface at a client device 540 and sent to the digital assets platform 10 via the network 570. In general, the current assets will be different from the original assets because the digital assets platform 510 will have been making trades according to the first strategy. The digital assets platform tags 760 the current digital assets selected for the second strategy as deposited assets indicating they are available for assignment and then transfers 770 the selected current digital assets to a wallet associated with the second strategy (e.g., a fund). Transferring 770 the current digital assets may be implemented by initiating one or more trades between the user's wallet and the wallet associated with the second strategy. In this way, the user can seamlessly associate assets to different types of strategies without significant delays or other overheads. Furthermore, from the user's perspective, assigning digital assets to different types of assets is done in the same way, with the differences in implementation between different strategies being automatically handled and accounted or by the digital assets platform 510.

### Computing System Architecture

FIG. 8 is a block diagram of an example computer 800 suitable for use within the networked computing environment 100. The example computer 800 includes at least one processor 802 coupled to a chipset 804. The chipset 804 includes a memory controller hub 820 and an input/output (I/O) controller hub 822. A memory 806 and a graphics adapter 812 are coupled to the memory controller hub 820, and a display 818 is coupled to the graphics adapter 812. A storage device 808, keyboard 810, pointing device 814, and network adapter 816 are coupled to the I/O controller hub 822. Other embodiments of the computer 800 have different architectures.

In the embodiment shown in FIG. 8, the storage device 808 is a non-transitory computer-readable storage medium such as a hard drive, compact disk read-only memory (CD-ROM), DVD, or a solid-state memory device. The memory 806 holds instructions and data used by the processor 802. The pointing device 814 is a mouse, track ball, touch-screen, or other type of pointing device, and may be used in combination with the keyboard 810 (which may be an on-screen keyboard) to input data into the computer system 800. The graphics adapter 812 displays images and other information on the display 818. The network adapter 816 couples the computer system 800 to one or more computer networks, such as network 170.

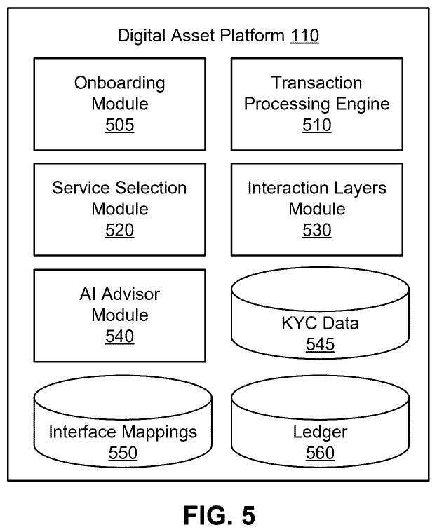

The types of computers used by the entities of FIGS. 1-8 can vary depending upon the embodiment and the processing power required by the entity. For example, the digital assets platform 110 might include multiple blade servers working together to provide the functionality described while a client device 140 might be a smartphone or tablet, etc. Furthermore, the computers can lack some of the components described above, such as keyboards 810, graphics adapters 812, and displays 818.

### ADDITIONAL CONSIDERATIONS

Some portions of above description describe the embodiments in terms of algorithmic processes or operations. These algorithmic descriptions and representations are commonly used by those skilled in the computing arts to convey the substance of their work effectively to others skilled in the art. These operations, while described functionally, computationally, or logically, are understood to be implemented by computer programs comprising instructions for execution by a processor or equivalent electrical circuits, microcode, or the like. Furthermore, it has also proven convenient at times, to refer to these arrangements of functional operations as modules, without loss of generality.

Any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

The terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs. Thus, while particular embodiments and applications have been illustrated and described, it is to be understood that the described subject matter is not limited to the precise construction and components disclosed. The scope of protection should be limited only by the following claims.

What is claimed is:

1. A computer-implemented method comprising:
receiving a selection of a strategy to implement;
accessing a set of native operations that define implementation of the selected strategy;
for at least one native operation in the set of native operations:
selecting a third-party provider to implement the native operation; and
retrieving a mapping between a format of the native operation and a format used by the selected third-party provider; and
implementing the set of native operations, wherein the implementing comprises directing the third-party provider to implement the at least one native operation using the mapping.

2. The method of claim 1, wherein the set of native operations comprises at least one of: asset transfers, smart contract executions, or trade order placements.

3. The method of claim 1, wherein selecting the third-party provider comprises:
selecting the third-party provider based on at least one of predicted completion time and probability of failure.

4. The method of claim 1, wherein the mapping between the native operation and the format used by the selected third-party provider is accessed from a database of interface mappings stored in one or more computer-readable media.

5. The method of claim 1, further comprising updating a database based on the implementing of the set of native operations.

6. The method of claim 1, further comprising adding a new third-party provider to those selectable by receiving a mapping between each of the set of native operations and a format used by the new third-party provider.

7. The method of claim 1, wherein implementing the set of native operations further comprising generating a protocol specific request for each of the set of native operations based on a corresponding mapping.

8. A computer-implemented method comprising:
receiving a first set of digital data items and a second set of digital data items for storing in a user-associated storage location of a computing system;
assigning a first status indicator to the first set of digital data items to denote their availability for processing by the computing system;
receiving a selection of a first processing mode for the first set of digital data items, the first processing mode having a first type;
associating the first set of digital data items with an identifier of the first processing mode, wherein the first set of digital data items remain in the user-associated storage location during processing by the first processing mode;
receiving a selection of a second processing mode for the second set of digital data items, the second processing mode having a second type;
assigning a second status indicator to the second set of digital data items to denote their availability for reassignment; and
transferring the digital data items from the user-associated storage location to a storage location associated with the second processing mode.

9. The method of claim 8, wherein the first status indicator comprises a tag or metadata field associated with the first set of digital data items to denote their availability for processing by the computing system.

10. The method of claim 8, wherein the first processing mode is a local processing mode in which digital data items remain in the user-associated storage location, and wherein the second processing mode is a remote processing mode in which digital data items are transferred to a different storage location.

11. The method of claim 8, further comprising providing a user interface on a client device for receiving the selection of the first processing mode and the second processing mode.

12. The method of claim 8, wherein the second processing mode is associated with a storage location that is shared among multiple users of the computing system.

13. The method of claim 8, further comprising updating a user profile to reflect the association of the first set of digital data items with the first processing mode.

14. The method of claim 8, wherein assigning the first status indicator or the second status indicator comprises updating a database or ledger to record a current status of the corresponding digital data items.

15. The method of claim 8, wherein transferring the digital data items to the storage location associated with the second processing mode comprises executing a set of native operations selected from the group consisting of: data transfer, format conversion, and access control modification.

16. The method of claim 8, wherein the selection of the second processing mode is based at least in part on real-time data regarding candidate service providers or system resources.

17. The method of claim 8, further comprising dividing the digital data items among a plurality of sub-locations within the storage location associated with the second processing mode, according to one or more allocation rules.

18. A non-transitory computer-readable medium storing instructions that, when executed by a computer system, cause the computer system to perform operations comprising:
receiving a selection of a strategy to implement;
accessing a set of native operations that define implementation of the selected strategy;
for at least one native operation in the set of native operations:
selecting a third-party provider to implement the native operation; and
retrieving a mapping between a format of the native operation and a format used by the selected third-party provider; and
implementing the set of native operations, wherein the implementing comprises directing the third-party provider to implement the at least one native operation using the mapping.
